(19) United States
(12) Patent Application Publication
(10) Pub. No.: US 2007/0114486 A1
(43) Pub. Date: May 24, 2007

(54) Electrically conductive magnetic fluid and use thereof

(75) Inventor: Masataka Takeuchi, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.

(21) Appl. No.: 11/586,567

(22) Filed: Oct. 26, 2006

Related U.S. Application Data
(60) Provisional application No. 60/732,718, filed on Nov. 3, 2005.

(30) Foreign Application Priority Data
Oct. 27, 2005 (JP) 2005-312287

(51) Int. Cl. H01B 1/22

(52) U.S. Cl. 252/62.52; 252/503; 252/506

(57) ABSTRACT

The conductive magnetic fluid which attains high response speed and large torque and exhibits sealing performance is obtained by dispersing, in a solvent such as silicone oil, ferromagnetic particles such as Ni—Fe alloy, iron, and magnetite, and carbon fiber having a mean fiber diameter of 10 to 500 nm and a mean aspect ratio of 30 to 200. The sealing device and the actuator are produced by use of the conductive magnetic fluid.

This application claims benefit of U.S. Provisional Application No. 60/732,718 filed on Nov. 3, 2005, the disclosure of which is incorporated herein by reference. This application is based on Japanese Patent Application No. 2005-312287 filed on Oct. 27, 2005, the contents of which are incorporated herein by reference.

### BACKGROUND OF THE INVENTION

1. Field of the Invention

The present invention relates to an electrically conductive (hereinafter referred to simply as “conductive”) magnetic fluid and to use thereof. More particularly, the invention relates to a conductive magnetic fluid in which specific finely-divided conductive carbon fiber filaments have been added to a magnetic fluid that is responsive to a magnetic field, and to a sealing device and an actuator employing the magnetic fluid.

2. Description of the Related Art

Magnetic fluid is a colloidal solution containing ferromagnetic particles uniformly dispersed in solvent. Upon bringing a magnet into close proximity to the magnetic fluid, the entirety of the liquid is drawn toward the magnet. That is, the liquid behaves as if it exhibits magnetism. Another characteristic feature of magnetic fluid is that the fluid induces strong force upon application of a magnetic field thereto. By virtue of this characteristic feature, the magnetic fluid is employed as a rotary shaft seal, and applications of the magnetic fluid to a damper, an actuator, gravity separation, an inkjet printer, etc. have been envisaged. Japanese Patent Application Laid-Open (kokai) No. 51-44579 discloses a typical method for producing a magnetic fluid, the method including preparing a magnetite/water slurry from an aqueous ferrous sulfate solution and an aqueous ferric sulfate solution, adding a surfactant to the slurry, washing the slurry with water, drying, and dispersing the dried product in an organic solvent.

Magnetic fluid generally has high electrical resistance. Therefore, when the magnetic fluid is employed in a sealing mechanism of a magnetic disk apparatus or a similar device, static electricity accumulated in the magnetic disk device or a like device (hereinafter referred to as a charging body) must be removed by means of a grounding mechanism. However, in the case where the magnetic fluid itself is endowed with conductivity, such charging can be prevented without employment of a grounding mechanism.

Meanwhile, in field-controlled energy conversion MHD (magnetohydrodynamic) power generation, a conductive working fluid traverses a magnetic field, thereby generating electromotive force, which is output by means of two electrodes. Thus, application of a conductive magnetic fluid to the working fluid has also been studied.

Some conductive magnetic fluids have already been proposed. Japanese Patent Application Laid-Open (kokai) No. 61-274737 discloses a magnetic fluid containing ferromagnetic particles each having a coating layer of a cationic surfactant such as a quaternary ammonium salt. Japanese Patent Application Laid-Open (kokai) No. 1-231302 discloses a magnetic fluid employing a conductivity-imparted solvent prepared by dissolving in solvent a conductivity-imparting substance formed of a tertiary amine and a fatty acid in combination. Japanese Patent Application Laid-Open (kokai) No. 5-255686 discloses a magnetic fluid employing an organic acid quaternary phosphonium salt serving as a conductivity-imparting agent.

Japanese Patent Application Laid-Open (kokai) No. 5-267035 discloses a magnetic fluid containing a ferromagnetic powder (e.g., magnetite powder, nickel powder, or cobalt powder) and a conductive powder (e.g., gold powder) which are dispersed in organic liquid.

However, the above disclosed magnetic fluids have drawbacks. Specifically, these fluids exhibit low magnetic permeability, which is an index for responsiveness, and thus fail to attain high response speed. When the fluids are employed as a sealant, sealing performance is unsatisfactory. These problems impede spreading of the magnetic fluids to a variety of uses.

### SUMMARY OF THE INVENTION

An object of the present invention is to provide a conductive magnetic fluid which attains high response speed and large torque and exhibits high sealing performance. Another object of the present invention is to provide a sealing device and an actuator which employ the conductive magnetic fluid and which exhibit high response speed, large torque, and excellent sealing performance.

In order to attain the aforementioned objects, the present inventors have conducted extensive studies on magnetic fluid, and have found that the objects can be attained by adding a conductive carbon fiber having specific morphological characteristics to fluid so as to develop conduction network in the fluid. The present invention has been accomplished on the basis of this finding.

Accordingly, the present invention provides

(1) A conductive magnetic fluid comprising at least one solvent, ferromagnetic particles of at least one species, and conductive carbonaceous particles of at least one species,

characterized in that the conductive carbonaceous particles of at least one species are carbon fiber having a mean fiber diameter of 10 to 500 nm and a mean aspect ratio of 30 to 200.

As preferred embodiments, the present invention provides the following.

(2) A conductive magnetic fluid as described in (1) above, wherein the carbon fiber has a CO value, as determined through X-ray diffractometry, of 0.65 nm to 0.68 nm and exhibits a resistivity of 0.015 Ωcm or less when compacted to a bulk density of 0.5 g/cm³.

(3) A conductive magnetic fluid as described in (1) or (2) above, wherein the carbon fiber has a hydrophilic surface.

(4) A conductive magnetic fluid as described in any of (1) to (3) above, wherein the ferromagnetic particles of at least one species are ferromagnetic metal element microparticles, ferromagnetic alloy microparticles, ferromagnetic oxide microparticles, and/or ferromagnetic nitride microparticles.

(5) A conductive magnetic fluid as described in any of (1) to (4) above, wherein the ferromagnetic particles of at least one species are

metal element microparticles, the metal element being iron, nickel, or cobalt;

alloy microparticles, the alloy containing iron, nickel, and/or cobalt;

oxide microparticles, the oxide containing iron, nickel, and/or cobalt; and/or

nitride microparticles, the nitride containing iron, nickel, and/or cobalt.

(6) A conductive magnetic fluid as described in any of (1) to (5) above, wherein the ferromagnetic particles of at least one species are Ni—Fe alloy particles, iron particles, or magnetite particles.

(7) A conductive magnetic fluid as described in any of (1) to (6) above, wherein said at least one solvent is a hydrocarbon solvent, an ester oil, an ether oil, a silicone oil, and/or a fluorocarbon oil.

(8) A conductive magnetic fluid as described in any of (1) to (7) above, wherein said at least one solvent is a mineral oil, an alkylnaphthalene, a poly(α-olefin), butyl phthalate, butyl sebacate, oligophenylene oxide, a silicone oil, and/or a fluorocarbon oil.

(9) A conductive magnetic fluid as described in any of (1) to (8) above, which contains the carbon fiber in an amount of 0.1 mass % to 30 mass %.

(10) A conductive magnetic fluid as described in any of (1) to (9) above, which contains the ferromagnetic particles in a total amount of 3 mass % to 80 mass %.

(11) A conductive magnetic fluid as described in any of (1) to (10) above, which exhibits a viscosity, as measured at 25° C. and under no magnetic field application, of 100 mPa·sec to 100,000 mPa·sec.

(12) A conductive magnetic fluid as described in any of (1) to (11) above, which exhibits an electrical conductivity, as measured at 25° C. and under application of a magnetic field of 1,500 Oe, of 10⁻² S/cm or more in the direction of the magnetic field.

The invention also provides the following.

(13) A sealing device employing the aforementioned conductive magnetic fluid.

(14) An actuator employing the aforementioned conductive magnetic fluid.

Since the conductive magnetic fluid of the present invention contains finely-divided carbon fiber filaments serving as conductive carbon particles, high response speed with respect to a magnetic field and large torque can be provided, leading to excellent sealing performance. Through employment of the conductive magnetic fluid, a sealing device and an actuator which exhibit high response speed, large torque, and excellent sealing performance can be provided.

### BRIEF DESCRIPTION OF THE DRAWINGS

FIG. 1 shows a flow diagram of an apparatus for producing the vapor grown carbon fiber of the present invention.

FIG. 2 shows the fiber diameter distribution profile of the carbon fiber produced in Example 1.

### DESCRIPTION OF REFERENCE NUMERALS

Reference numerals used to identify various structural features shown in the drawings including the following.
1. Raw material
2a, 2b. Carrier gas
3. Gasifier
4. Stirring apparatus
5. Reaction tube

### DETAILED DESCRIPTION OF THE PREFERRED EMBODIMENTS

The conductive magnetic fluid of the present invention contains at least one solvent, ferromagnetic particles of at least one species, and conductive carbonaceous particles of at least one species. In the conductive magnetic fluid of the present invention, the conductive carbonaceous particles of at least one species are carbon fiber having a mean fiber diameter of 10 to 500 nm and a mean aspect ratio of 30 to 200.

<Conductive Carbonaceous Particles>

The conductive carbonaceous particles contained in the conductive magnetic fluid of the present invention are carbon fiber.

The carbon fiber has a mean fiber diameter of 10 to 500 nm, preferably 20 to 140 nm. Preferably, filaments of the carbon fiber exhibit less variation in fiber diameter, and variation in fiber diameter is such that the filaments of the carbon fiber having a diameter falling within a range of the mean fiber diameter ±20% account for 65% (on a number basis) or more, more preferably 70% (on a number basis) or more, particularly preferably 75% (on a number basis) or more, of all the filaments of the carbon fiber. The expression “filaments of the carbon fiber having a fiber diameter falling within a range of the mean fiber diameter ±20% account for 65% (on a number basis) or more of all the filaments of the carbon fiber” refers to the case where, for example, when the mean fiber diameter is 100 nm, filaments of the carbon fiber having a fiber diameter of 80 to 120 nm account for 65% or more of all the fiber filaments of the carbon fiber.

The carbon fiber employed in the present invention has a mean aspect ratio of 30 to 200.

The vapor grown carbon fiber employed in the present invention preferably has a bulk density of 0.030 g/cm³ or less, more preferably 0.010 g/cm³ or less. When the bulk density of the carbon fiber is in excess of 0.030 g/cm³, the effect of enhancing conductivity of the magnetic fluid tends to be reduced.

The bulk density of carbon fiber is obtained through the following procedure: produced carbon fiber is heated in an argon atmosphere at 1,000° C. for 15 minutes; the thus-heated carbon fiber is subjected to milling for one minute by use of a mixer (MX-X62, product of Matsushita Electric Industrial Co., Ltd.); the thus-milled carbon fiber is placed in a measuring cylinder and then vibrated for one minute by use of a vibrator (Touch Mixer MT-31, product of Yamato); and the apparent volume of the resultant carbon fiber is measured, followed by calculation of the bulk density from the weight and the apparent volume.

The carbon fiber employed in the present invention preferably has a resistivity of 0.015 Ωcm or less. When the resistivity of the carbon fiber is 0.015 Ωcm or less, conductivity of a resin-carbon fiber composite can be enhanced through addition of the carbon fiber to a resin paste in an amount of about 2 mass %. The resistivity of the carbon fiber is obtained by measuring resistivity of a compacted product of the carbon fiber having a bulk density of 0.5 g/cm³.

No particular limitation is imposed on the method for producing the carbon fiber employed in the present invention. Preferably, the carbon fiber is a vapor grown carbon fiber produced through a method including vaporizing a carbon source and a transition metal compound and jetting the formed vapor toward the inner wall of a reactor, for thermal decomposition.

The carbon source (organic compound) serving as a raw material of the carbon fiber may be any gasifiable organic compound. However, preferably, the carbon source is an organic compound which is gasified at a lower temperature. Specific examples of employable carbon source include aromatic compounds such as benzene, toluene, and xylene; linear hydrocarbons such as hexane and heptane; cyclic hydrocarbons such as cyclohexane; alcohols such as methanol and methanol; gasoline; and kerosene. Of these, aromatic compounds are preferred, with benzene being most preferred. These carbon sources may be employed singly or in combination of two or more species.

The transition metal compound serving as a catalyst is preferably an organometallic compound or an inorganic compound containing a transition metal belonging to Groups 4 to 10. Particularly, an organometallic compound containing a transition metal selected from the group consisting of Fe, Ni, and Co is preferred. In the present invention, the transition metal compound is reacted in the form of gas. Therefore, a transition metal compound having high vapor pressure is used. Specifically, a transition metal compound having a vapor pressure of 133 Pa (1 mmHg) or higher at 150° C. is preferred. Specific examples of high-vapor-pressure compounds include ferrocene and nickelocene.

The diameter, length, and particle content of the formed carbon fiber can be controlled by regulating the concentration of the transition metal compound. In order to produce carbon fiber having a fiber diameter of, for example, 80 nm or more, the amount of ferrocene is preferably regulated to 1 to 5 mass %, more preferably 2 to 4 mass %, on the basis of the entirety of the carbon source. When the amount of the catalyst falls within the above range, fiber parameters such as diameter can be readily controlled. Addition of a sulfur source to the raw material enables further enhancement of productivity of the carbon fiber. The sulfur source may be any gasifiable sulfur compound. However, preferably, the sulfur source is a sulfur compound having a high vapor pressure; specifically, a sulfur compound having a vapor pressure of 10 mmHg or higher at 50° C. Examples of the sulfur source include organic sulfur compounds such as thiophene; and inorganic sulfur compounds such as hydrogen sulfide. Particularly, thiophene is preferred. These sulfur sources may be employed singly or in combination of two or more species.

In the present invention, the aforementioned carbon source, transition metal compound, and sulfur source (i.e., optional component) are jetted in the form of gas to a reactor, to thereby allow reaction to proceed. In this case, the carbon source, transition metal compound, and sulfur source may be separately gasified, and the thus-gasified materials may be mixed together before being jetted into the reactor. However, preferably, a liquid raw material is prepared from the carbon source, transition metal compound, and sulfur source, and the thus-prepared raw material is gasified and then jetted into the reactor.

Through jetting the raw material gas toward the inner wall of the reactor, the raw material can be heated efficiently, and thermal decomposition of the raw material can be promoted, leading to enhancement in carbon fiber yield. In addition, carbon fiber filaments having less variation in fiber diameter can be produced.

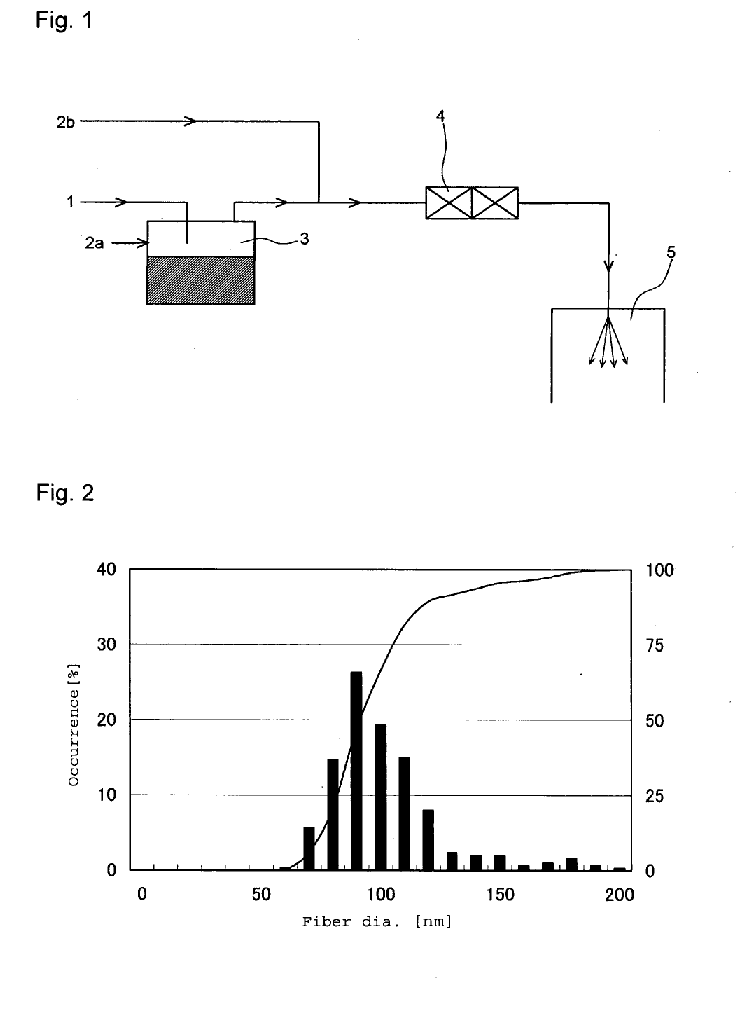

FIG. 1 shows a flow diagram of an apparatus employed in the vapor grown carbon fiber production method suitably employed in the present invention.

A liquid raw material (1) is brought into a gasifier (3) by use of a liquid feed pump (not illustrated), whereby a raw material gas is prepared. In order to attain a constant composition of the raw material gas, preferably, the entire amount of the liquid raw material is gasified. The gasifier is heated to a temperature such that the liquid raw material is completely gasified and the liquid raw material is not decomposed. The heating temperature is preferably 200 to 700° C., more preferably 350 to 550° C. The liquid raw material is efficiently gasified by spraying the raw material to the inner wall of the gasifier through a spray nozzle unit. In order to control the feed rate of the raw material gas, a carrier gas (2a) may be introduced into the gasifier. However, from the viewpoint of reduction of load to the heater of the gasifier, preferably, the flow rate of the carrier gas is reduced to a minimum possible level.

The gasified raw material fed from the gasifier is mixed with a carrier gas (2b). The carrier gas preferably contains a reducing gas such as hydrogen. Through employment of a reducing gas, catalytic activity of the transition metal compound is elevated, and deactivation is prevented. The amount of carrier gas is preferably 1 to 100 mol on the basis of 1.0 mol of the organic compound (i.e., the carbon source). The raw material gas and the carrier gas are uniformly mixed together by means of a static mixer (STP) (4). Through uniform mixing, carbon fiber exhibiting excellent dispersibility can be produced.

The aforementioned mixture of the raw material gas and the carrier gas is jetted into the reactor (5), whereby the raw material gas is thermally decomposed, and carbon fiber is produced. The temperature in the interior of the reactor is regulated to 800 to 1,300° C., preferably 900 to 1,250° C. The reactor is formed of a material which endures a reaction temperature of 1,300° C., such as alumina, zirconia, magnesia, silicon nitride, or silicon carbide. The reactor preferably assumes a tubular form. The tubular reactor (reaction tube) is heated by means of a heater provided outside the tube. When the residence time of the raw material in the reactor is increased so that the raw material is completely decomposed, the yield of carbon fiber is enhanced. Specifically, the residence time of the raw material in the reactor at 1,250° C. is 2 to 10 seconds, preferably 4 to 6 seconds.

The carbon fiber produced through the aforementioned thermal decomposition process may be employed without any further treatment. Alternatively, the carbon fiber may be heated at about 800 to about 2,000° C. for removal of impurities therefrom, or may be heated at 2,000° C. or higher for enhancement of crystallinity thereof, i.e., graphitization. In the present invention, a carbon fiber which has been graphitized through heating at 2,000° C. or higher is preferably employed, since the graphitized carbon fiber has higher conductivity, a smaller impurity content, and higher stability. The graphitized carbon fiber preferably has a graphitization degree (represented by CO value), as determined through X-ray diffractometry, of 0.65 nm to 0.68 nm.

In order to improve wettability of the carbon fiber to a matrix and dispersibility of the carbon fiber to the matrix, thereby increasing the interfacial strength between the carbon fiber and the matrix, the surface of the carbon fiber is preferably modified, to thereby exhibit hydrophilicity. The surface modification is preferably surface oxidation. Surface oxidation of the carbon fiber may be performed through, for example, heating of the carbon fiber in the presence of an oxidizing gas, or immersing the carbon fiber in an oxidizing liquid and heating of the thus-immersed carbon fiber in accordance with needs. From the viewpoint of convenience, preferably, the surface oxidation is performed by heating the carbon fiber in air at 300 to 800° C.

The conductive carbonaceous particles employable in the conductive magnetic fluid of the present invention may be formed solely of the aforementioned carbon fiber or may further contain other additional conductive particles. The aforementioned carbon fiber imparts sufficiently high conductivity to the magnetic fluid when added even in a small amount. However, since the carbon fiber is bulky, difficulty is encountered in addition thereof in a large amount so as to attain high conductivity. Therefore, higher conductivity can be attained through combinatory use of less bulky blocky or spherical conductive carbonaceous particles. In this case, when blocky or spherical conductive particles are used at high concentration, sedimentation of carbon fiber can be prevented. Thus, use of carbon fiber and blocky or spherical conductive particles in combination is preferred by virtue of the synergistic effect.

No particular limitation is imposed on the type of blocky or spherical conductive carbonaceous particles which are used in combination with carbon fiber in the present invention. Examples of such carbonaceous particles include carbon particles such as carbon black particles and natural and artificial graphite particles. These blocky or spherical conductive carbonaceous particles preferably have a mean particle size of 0.1 to 10 μm, more preferably 0.2 to 3 μm from the viewpoint of dispersibility, viscosity, and operability. The mean particle size may be determined by means of a laser-scattering type particle size distribution measuring apparatus or a similar apparatus.

When carbon fiber and other blocky or spherical conductive carbonaceous particles are used in combination, the ratio in amount of carbon fiber to carbonaceous particles is not particularly limited. Carbon fiber is preferably used in an amount of 100 to 500 parts by mass, more preferably 200 to 400 parts by mass, with respect to 100 parts by mass of other blocky or spherical conductive carbonaceous particles.

During production of the conductive magnetic fluid of the present invention, a dispersant or a coupling agent serving as an additive may be used in order to enhance dispersibility of carbon fiber and/or other conductive carbonaceous particles.

No particular limitation is imposed on the type of the dispersant. Examples of the dispersant include saturated higher fatty acids such as palmitic acid and stearic acid and metal salts thereof; and unsaturated higher fatty acids such as oleic acid and linolenic acid and metal salts thereof. Generally, these dispersants are added in a total amount of 1 to 100 parts by mass based on 100 parts by mass of conductive carbonaceous particles. When the total amount is less than 1 part by mass, dispersibility of carbon fiber and/or other conductive carbonaceous particles cannot fully be enhanced, whereas when the total amount is in excess of 100 parts by mass, stability of the conductive magnetic fluid may be impaired.

Examples of the coupling agent include silane-based coupling agents such as vinylmethoxysilane, vinyltriethoxysilane, and vinyltris(β-methoxyethoxy)silane; titanate-based coupling agents; and aluminate-based coupling agents. Preferably, these coupling agents are added in a total amount of 30 parts by mass or less based on 100 parts by mass of conductive carbonaceous particles. Similar to the dispersant, when the total amount is excessively large, stability of the conductive magnetic fluid may be impaired.

<Ferromagnetic Particles>

Examples of the ferromagnetic particles forming the conductive magnetic fluid of the present invention include ferromagnetic metal element microparticles, ferromagnetic alloy microparticles, ferromagnetic oxide microparticles, and/or ferromagnetic nitride microparticles. Specific examples include metal element microparticles, the metal element being iron, nickel, or cobalt; alloy microparticles, the alloy containing iron, nickel, and/or cobalt; oxide microparticles, the oxide containing iron, nickel, and/or cobalt; and/or nitride microparticles, the nitride containing iron, nickel, and/or cobalt. The ferromagnetic particles may contain a rare earth metal element such as samarium, neodymium, or cerium. Of these, magnetic metal particles of iron, cobalt, nickel, Ni—Fe alloy, and a similar metal, and magnetic metal oxide particles of ferrite, magnetite, and a similar oxide are preferred, from the viewpoint of relatively high magnetism and ease of handling. In the present invention, the term “magnetism” refers to responsiveness to a magnetic field; e.g., a property of being drawn toward a magnet.

The ferromagnetic particles employed in the present invention preferably have a particle size of 0.003 to 200 μm. When the particle size is smaller than 0.003 μm, weak magnetism results, whereas when the particle size is in excess of 200 μm, dispersibility of the particles in the magnetic fluid becomes poor. The ferromagnetic particles employed in the present invention include hard magnetic particles and soft magnetic particles. The hard magnetic particles preferably have a particle size of 0.003 to 0.5 μm, and the soft magnetic particles preferably have a particle size of 0.1 to 200 μm. In order to obtain highly intense magnetic power, soft magnetic particles having a particle size of 1 to 100 μm are preferably employed.

<Solvent>

No particular limitation is imposed on the solvent forming the conductive magnetic fluid of the present invention, and solvents which are stable in air and at high and low temperatures are preferred. The solvent suited for the present invention preferably has a boiling point of 150 to 700° C. (normal pressure) and a viscosity of 10 to 5,000 mPa·sec (40° C.), more preferably 200 to 650° C. (normal pressure) and 50 to 3,000 mPa·sec (40° C.), respectively. Examples of the solvent include hydrocarbon solvents such as a mineral oil, an alkylnaphthalene, and a poly(α-olefin); ester oils such as butyl phthalate and butyl sebacate; ether oils such as oligophenylene oxide; a silicone oil; and a fluorocarbon oil.

<Conductive Magnetic Fluid>

Without application of a magnetic field, the conductive magnetic fluid of the present invention assumes a viscous liquid having fluidity. Preferably, the magnetic fluid exhibits a viscosity, as measured at 25° C. and under no magnetic field application, of 100 mPa·sec to 100,000 mPa·sec. When the viscosity is low, separation of particles readily occurs under no magnetic field application, whereas when the viscosity is high, the fluid is difficult to handle and tends to exhibit poor responsiveness.

The conductive magnetic fluid of the present invention preferably exhibits an electrical conductivity, as measured at 25° C. and under application of a magnetic field of 1,500 Oe, of 10⁻² S/cm or more in the direction of the magnetic field. When the conductivity is lower than 10⁻² S/cm, orientation of carbon fiber is poor, and the effect of enhancing response speed is difficult to attain.

In the conductive magnetic fluid of the present invention, the ratio by mass of ferromagnetic particles to solvent is preferably 1/99 to 90/10, more preferably 5/95 to 60/40. When the amount of solvent is small, viscosity of the magnetic fluid increases, failing to attain function of fluid per se, whereas when the amount of solvent is excessively large, magnetic effect tends to be impaired. Other additives such as a surfactant may be added to the magnetic fluid so long as effects of the present invention are not impaired.

The conductive magnetic fluid of the present invention preferably contains carbon fiber in an amount of 0.1 mass % to 30 mass %, more preferably 0.1 mass % to 20 mass %, particularly preferably 0.5 mass % to 15 mass %. When the amount of carbon fiber is small, conductivity tends to decrease, whereas when the amount of carbon fiber is large, viscosity of the magnetic fluid tends to increase. The conductive magnetic fluid preferably contains ferromagnetic particles in a total amount of 3 mass % to 80 mass %.

<Use>

The conductive magnetic fluid of the present invention may be employed in a suspension system (e.g., an engine mount or a shock absorber), a clutch member, a torque converter, a brake system, a valve, a damper, a suspension, an actuator, a vibrator, an ink-jet printer, a sealing member, means for gravity separation, a bearing, a polishing material, a packing, a control valve, and a damping material.

Through employment of the conductive magnetic fluid of the present invention, which exhibits high conductivity and excellent magnetism, there can be produced a sealing device for use in a hard disk drive or a similar apparatus which device attains high torque, excellent sealability, and consistent performance. In addition, since the conductive magnetic fluid of the present invention exhibits high response speed during operation, the magnetic fluid is suitable for a variety of actuators.

The present invention will next be described in more detail by way of Examples, which should not be construed as limiting the invention thereto.

### PRODUCTION EXAMPLE

<Production of Vapor Grown Carbon Fiber>

Vapor grown carbon fiber was produced by use of an apparatus whose flow diagram is shown in FIG. 1.

As a reaction tube (5) was employed a vertical heating furnace (inner diameter: 370 mm, length: 2,000 mm) having, on its top, a raw material gas feed nozzle unit.

A liquid raw material was prepared by dissolving ferrocene (0.5 kg) and thiophene (0.13 kg) in benzene (14 kg). The ferrocene and thiophene contents of the liquid raw material were found to be 3.5 mass % and 0.9 mass %, respectively.

The temperature of a gasifier (3) was regulated to 500° C. Nitrogen gas was caused to pass through the gasifier, to thereby purge oxygen gas from the gasifier. Subsequently, hydrogen gas was caused to pass through the gasifier, to thereby fill the gasifier with hydrogen gas.

Thereafter, the temperature of the reaction tube (5) was elevated to 1,250° C. A liquid raw material (30 g/min) was fed into the gasifier by use of a pump, to thereby gasify the raw material. The thus-gasified raw material was discharged from the gasifier by use of hydrogen gas (50 L/min) serving as a carrier gas (2a ). Subsequently, the raw material gas was uniformly mixed with hydrogen gas (400 L/min) serving as a carrier gas (2b) by means of a static mixer (4). The gas mixture was jetted into the reaction tube (5), and reaction was allowed to proceed for a residence time of one hour. The reaction product was heated in an argon atmosphere at 2,800° C. for 30 minutes, to thereby produce carbon fiber.

The thus-produced carbon fiber was found to have a bulk density of 0.012 g/min. When compacted to a bulk density of 0.5 g/cm³, the carbon fiber was found to exhibit a resistivity of 0.007 Ωcm. Through observation of 100 filaments of the carbon fiber under a scanning electron microscope, the mean fiber diameter and the mean fiber length were calculated. As a result, the mean fiber diameter was found to be 96.9 nm (standard deviation: 23.4 nm), and the mean fiber length was found to be 13 μm (mean aspect ratio: 130). FIG. 2 shows the fiber diameter distribution profile of the carbon fiber. Filaments of the carbon fiber having a fiber diameter falling within a range of +20% the mean fiber diameter were found to account for 75% (on a number basis) of all the filaments of the carbon fiber. The carbonization yield (i.e., mass of the produced carbon fiber/mass of the fed benzene) was found to be 50%.

<Determination of BET Specific Surface Area and Micropore Volume>

A nitrogen adsorption isotherm (at liquid nitrogen temperature) was obtained by use of NOVA 1200 (product of Quantachrome). BET specific surface area and micropore volume were calculated from the adsorption isotherm through the BET method and the BJH method, respectively.

Example 1

Permalloy (Ni—Fe alloy) powder (mean particle size: 10 μm) (30 g) and vapor grown carbon fiber produced in Production Example (3 g) were dispersed in silicone oil (viscosity (25° C.): 200 mPa·sec) (KF-96, product of Shin-Etsu Silicones) (70 g), to thereby prepare magnetic fluid (A). Magnetic fluid (A) was found to have a saturation magnetization of 40 G. Upon bringing a magnet into close proximity to the magnetic fluid, the fluid was drawn toward the magnet.

Magnetic characteristics of the magnetic fluid were evaluated by means of a measuring apparatus including a cell in which two electrode plates each having a surface area of 400 mm² were disposed opposite each other with a clearance of 1 mm, and an electromagnet attached to the surface of each electrode plate. The apparatus was placed such that the electrode plates were aligned horizontally, and the cell was filled with magnetic fluid (A). Torque was determined when the upper electrode plate was moved toward the horizontal direction. Response speed was determined by use of an oscillograph, from the delay in torque following magnetic field application.

Magnetic fluid (A) was found to exhibit a viscosity, as measured at 25° C. and under no magnetic field application, of 3,530 mPa·sec and an electrical conductivity, as measured at 25° C. and under application of a magnetic field of 1,500 Oe, of 3.5×10⁻¹ S/cm in the direction of the magnetic field.

Magnetic fluid (A) was found to have a torque of 24 gf·cm as measured under no magnetic field application, and 240 gf·cm as measured under application of a magnetic field of 1,500 Oe. Response speed was found to be 0.10 sec.

Example 2

The procedure of Example 1 was repeated, except that the amount of vapor grown carbon fiber employed in Example 1 was changed to 2.0 g, and artificial graphite powder (UFG10, product of Showa Denko K.K., mean particle size: 5 μm) (1.0 g) was used, to thereby prepare magnetic fluid (B). Magnetic fluid (B) was found to have a saturation magnetization of 560 G. Upon bringing a magnet into close proximity to the magnetic fluid, the fluid was drawn toward the magnet. Magnetic characteristics of the magnetic fluid were evaluated by means of a measuring apparatus including a cell in which two electrode plates each having a surface area of 400 mm² were disposed opposite each other with a clearance of 1 mm, and an electromagnet attached to the surface of each electrode plate. The apparatus was placed such that the electrode plates were aligned horizontally, and the cell was filled with magnetic fluid (B). Torque was determined when the upper electrode plate was moved toward the horizontal direction. Response speed was determined by use of an oscillograph, from the delay in torque following magnetic field application.

Magnetic fluid (B) was found to exhibit a viscosity, as measured at 25° C. and under no magnetic field application, of 4,280 mPa·sec and an electrical conductivity, as measured at 25° C. and under application of a magnetic field of 1,500 Oe, of 2.5×10⁻¹ S/cm in the direction of the magnetic field.

Magnetic fluid (B) was found to have a torque of 20 gf·cm as measured under no magnetic field application, and 280 gf·cm as measured under application of a magnetic field of 1,500 Oe. Response speed was found to be 0.15 sec.

Comparative Example 1

The procedure of Example 1 was repeated, except that vapor grown carbon fiber (3 g) was not used, to thereby prepare magnetic fluid (C). Magnetic fluid (C) was found to have a saturation magnetization of 430 G. Upon bringing a magnet into close proximity to the magnetic fluid, the fluid was drawn toward the magnet. Magnetic characteristics of the magnetic fluid were evaluated in a manner similar to that employed in Example 1.

Magnetic fluid (C) was found to exhibit a viscosity, as measured at 25° C. and under no magnetic field application, of 2,730 mPa·sec and an electrical conductivity, as measured at 25° C. and under application of a magnetic field of 1,500 Oe, of 3.5×10⁻³ S/cm in the direction of the magnetic field.

Magnetic fluid (C) was found to have a torque of 18 gf·cm as measured under no magnetic field application, and 188 gf·cm as measured under application of a magnetic field of 1,500 Oe. Response speed was found to be 3.50 sec.

Example 3

The procedure of Example 2 was repeated, except that iron powder (mean particle size: 0.4 μm) was used instead of permalloy powder, to thereby prepare magnetic fluid (D). Magnetic fluid (D) was found to have a saturation magnetization of 380 G. Upon bringing a magnet into close proximity to the magnetic fluid, the fluid was drawn toward the magnet. Magnetic characteristics of the magnetic fluid were evaluated in a manner similar to that employed in Example 2.

Magnetic fluid (D) was found to exhibit a viscosity, as measured at 25° C. and under no magnetic field application, of 4,830 mPa·sec and an electrical conductivity, as measured at 25° C. and under application of a magnetic field of 1,500 Oe, of 8.1×10⁻¹ S/cm in the direction of the magnetic field.

Magnetic fluid (D) was found to have a torque of 35 gf·cm as measured under no magnetic field application, and 215 gf·cm as measured under application of a magnetic field of 1,500 Oe. Response speed was found to be 0.06 sec.

Comparative Example 2

The procedure of Comparative Example 1 was repeated, except that iron powder (mean particle size: 0.4 μm) was used instead of permalloy powder, to thereby prepare magnetic fluid (E). Magnetic fluid (E) was found to have a saturation magnetization of 380 G. Upon bringing a magnet into close proximity to the magnetic fluid, the fluid was drawn toward the magnet. Magnetic characteristics of the magnetic fluid were evaluated in a manner similar to that employed in Comparative Example 1.

Magnetic fluid (E) was found to exhibit a viscosity, as measured at 25° C. and under no magnetic field application, of 3,180 mPa·sec and a, electrical conductivity, as measured at 25° C. and under application of a magnetic field of 1,500 Oe, of 7.2×10⁻³ S/cm in the direction of the magnetic field.

Magnetic fluid (E) was found to have a torque of 28 gf·cm as measured under no magnetic field application, and 159 gf·cm as measured under application of a magnetic field of 1,500 Oe. Response speed was found to be 0.30 sec.

Example 4

The procedure of Example 2 was repeated, except that magnetite powder (mean particle size: 1.0 μm) was used instead of permalloy powder, to thereby prepare magnetic fluid (F). Magnetic fluid (F) was found to have a saturation magnetization of 380 G. Upon bringing a magnet into close proximity to the magnetic fluid, the fluid was drawn toward the magnet. Magnetic characteristics of the magnetic fluid were evaluated in a manner similar to that employed in Example 2.

Magnetic fluid (F) was found to exhibit a viscosity, as measured at 25° C. and under no magnetic field application, of 3,830 mPa·sec and an electrical conductivity, as measured at 25° C. and under application of a magnetic field of 1,500 Oe, of 1.5×10⁻¹ S/cm in the direction of the magnetic field.

Magnetic fluid (F) was found to have a torque of 35 gf·cm as measured under no magnetic field application, and 215 gf·cm as measured under application of a magnetic field of 1,500 Oe. Response speed was found to be 0.06 sec.

What is claimed is:

1. A conductive magnetic fluid comprising at least one solvent, at least one ferromagnetic particle, and at least one conductive carbonaceous particle,
wherein the conductive carbonaceous particle is carbon fiber having a mean fiber diameter of 10 to 500 nm and a mean aspect ratio of 30 to 200.

2. The conductive magnetic fluid according to claim 1, wherein the carbon fiber has a C0 value, as determined through X-ray diffractometry, of 0.65 nm to 0.68 nm and exhibits a resistivity of 0.015 Ωcm or less when compacted to a bulk density of 0.5 g/cm³.

3. The conductive magnetic fluid according to claim 1, wherein the carbon fiber has a hydrophilic surface.

4. The conductive magnetic fluid according to claim 1, wherein the ferromagnetic particle comprises ferromagnetic metal simple substance microparticles, ferromagnetic alloy microparticles, ferromagnetic oxide microparticles, and/or ferromagnetic nitride microparticles.

5. The conductive magnetic fluid according to claim 1, wherein the ferromagnetic particle comprises microparticles of metal simple substance being iron, nickel, or cobalt; microparticles of alloy containing iron, nickel, and/or cobalt; microparticles of oxide containing iron, nickel, and/or cobalt; and/or microparticles of nitride containing iron, nickel, and/or cobalt.

6. The conductive magnetic fluid according to claim 1, wherein the ferromagnetic particle comprises Ni—Fe alloy particles, iron particles, or magnetite particles.

7. The conductive magnetic fluid according to claim 1, wherein the solvent comprises a hydrocarbon solvent, an ester oil, an ether oil, a silicone oil, and/or a fluorocarbon oil.

8. The conductive magnetic fluid according to claim 1, wherein the solvent comprises a mineral oil, alkyl-naphthalene, poly(α-olefin), butyl phthalate, butyl sebacate, oligophenylene oxide, a silicone oil, and/or a fluorocarbon oil.

9. The conductive magnetic fluid according to claim 1, in which the amount of the carbon fiber is 0.1% by mass to 30% by mass.

10. The conductive magnetic fluid according to claim 1, in which the amount of the ferromagnetic particles is 3% by mass to 80% by mass.

11. The conductive magnetic fluid according to claim 1, which exhibits a viscosity, as measured at 25° C. and under no magnetic field application, of 100 mPa·sec to 100,000 mPa·sec.

12. The conductive magnetic fluid according to claim 1, which exhibits an electrical conductivity, as measured at 25° C. and under application of a magnetic field of 1,500 Oe, of 10⁻² S/cm or more in the direction of the magnetic field.

13. A sealing device employing a conductive magnetic fluid according to claim 1.

14. An actuator employing a conductive magnetic fluid according to claim 1.
